(19) United States
(12) Patent Application Publication
(10) Pub. No.: US 2015/0168185 A1
(43) Pub. Date: Jun. 18, 2015

(54) SENSING SYSTEM HAVING A RE-MODULARIZED SENSING DEVICE AND INITIALIZATION METHOD USING THE SAME

(71) Applicant: National Applied Research Laboratories, Hsinchu City (TW)

(72) Inventors: Chun-Ming HUANG, Hsinchu City (TW); Chien-Ming Wu, Hsinchu City (TW); Chih-Chyau Yang, Hsinchu City (TW); Kai-Chao Yang, Hsinchu City (TW); Shao-Min Wen, Hsinchu City (TW); Yi-Jun Liu, Hsinchu City (TW)

(21) Appl. No.: 14/326,526

(22) Filed: Jul. 9, 2014

Related U.S. Application Data
(60) Provisional application No. 61/917,788, filed on Dec. 18, 2013.

(51) Int. Cl. G01D 21/00; G01D 11/00

(52) U.S. Cl. CPC G01D 21/00; G01D 11/00

(57) ABSTRACT

A re-modularized sensing device is disclosed, which is especially for a sensing system having a power unit, a sensing unit, a processing unit, and a transceiver unit is disclosed. The power unit provides electricity for the modularized sensing device. The sensing unit derives at least one environmental data. The processing unit has a sensing device processing application program for calculating the environmental data and generating a first outcome. The transceiver unit transfers the first outcome and a first signal to the host. And one or more modules are formed by the sensing unit, the processing unit, and the power unit, and each module is individually removable and replaceable. And an initialization method of the sensing system using the re-modularized sensing device is also disclosed.

### CROSS REFERENCE TO RELATED APPLICATION

This application claims the benefit of U.S. Provisional Application Ser. No. 61/917,788, filed on Dec. 18, 2013.

### BACKGROUND OF THE INVENTION

1. Field of Invention

The present invention relates to a sensing system and an initialization method using the same, in particular, a sensing system having a re-modularized sensing device.

2. Description of Prior Art

In the prior art, a sensing device is a fixed suite of products, which is applied for a specific situation to which is applicable. When the situation is changed, the user must use another sensing device, not the same sensing device.

However, each sensing device differs only in a sensing unit and operation software, but most of the rest of the units of the sensing device are similar to those of another sensing device. For example, a light sensing device is applied for light detection. When a user hopes to detect temperature, humidity, pressure or other environmental parameters, the only way to solve the above issue is to buy another sensing device. In other words, when user needs to derive environmental parameters other than light, the light sensing device of the prior art cannot derive the desired environmental parameters apparently.

However, a power unit, a processing unit, and other units of the light sensing device mentioned above are still useful. Therefore, the present invention provides a solution to increase the applicable situations of a single sensing device, and such a sensing device is not limited to adapt to only one specific situation.

### BRIEF SUMMARY OF THE INVENTION

In order to solve the problems of the prior art, one purpose of the present invention is to provide a sensing system having a re-modularized sensing device, the sensing system comprises a host and a re-modularized sensing device.

The re-modularized sensing device comprises a power unit, a sensing unit, a processing unit, and a transceiver unit. Each sensing unit, processing unit, transceiver unit, and power unit has an ID.

The power unit provides electricity for the re-modularized sensing device. The sensing unit derives at least one environmental data. The processing unit has a sensing device processing application program built therein for calculating the environmental data and generating a first outcome. The transceiver unit transfers the first outcome and a first signal to the host. The sensing unit, processing unit, transceiver unit, and power unit are assembled into one or more modules, and each module is individually removable and replaceable.

Each of the modules has at least one connector, and the connectors of two modules form electrical and mechanical connections therebetween when the two modules are assembled.

In one preferred embodiment, the first signal comprises information of the ID of the sensing unit.

In one preferred embodiment, the host further comprises a host temporary table and a host database.

The host database stores at least one host application program and sensing device processing application program corresponding to the ID. The host temporary table stores an address of each ID in the host database. The re-modularized sensing device preliminarily calculates the environmental data by the sensing device processing application program, and the host calculates the first outcome by the host application program.

In one preferred embodiment, each module has at least one connector, the re-modularized sensing device further comprises a device cover, the device cover comprises a plurality of slots, and each module is installed into the device cover by connecting the connectors with the slots.

In order to solve the problems of the prior art, another purpose of the present invention is to provide a sensing system having a re-modularized sensing device. The sensing system comprises a host, a re-modularized sensing device, and a remote server. The host communicates with the remote server.

The re-modularized sensing device comprises a power unit, a sensing unit, a processing unit, and a transceiver unit. Each sensing unit, processing unit, transceiver unit, and power unit has an ID.

The power unit provides electricity for the re-modularized sensing device. The sensing unit derives at least one environmental data. The processing unit has a sensing device processing application program built therein for calculating the environmental data and generating a first outcome. The transceiver unit transfers the first outcome and a first signal to the host. The sensing unit, processing unit, transceiver unit, and power unit are assembled into one or more modules, and each module is individually removable and replaceable.

Each of the modules has at least one connector, and the connectors of two modules form electrical and mechanical connections therebetween when the two modules are assembled.

In one preferred embodiment, the first signal comprises information of the ID of the sensing unit.

In one preferred embodiment, the host further comprises a host temporary table and a host database.

The host database stores at least one host application program and sensing device processing application program corresponding to the ID. The host temporary table stores an address of each ID in the host database. The re-modularized sensing device preliminarily calculates the environmental data by the sensing device processing application program, and the host further calculates the first outcome by the host application program.

In one preferred embodiment, the remote server further comprises an ID decoder, a remote server temporary table, and a remote server database.

The ID decoder decodes the ID transferred from the host. The remote server temporary table stores an address of each ID in the remote server database. The remote server database stores at least one host application program and sensing device processing application program corresponding to the ID.

In one preferred embodiment, each module has at least one connector, the re-modularized sensing device further comprises a device cover, the device cover comprises a plurality of slots, and each module is installed into the device cover by connecting the connectors with the slots.

In order to solve the problems of the prior art, yet another purpose of the present invention is to provide an initialization method of a sensing system using a re-modularized sensing device, the method comprises:

First, a connection between the re-modularized sensing device and a host is established when the sensing unit is not supported by the re-modularized sensing device. Second, an ID of the sensing unit is transferred to the host. Third, the host checks whether the ID of the sensing unit exists in a host temporary table of the host. Fourth, data is downloaded from a host database of the host to update a sensing device processing application program if the ID exists in the host temporary table. Fifth, the host checks whether a host application program of the host needs to be updated. Sixth, data is downloaded from the host database of the host to update the host application program if the host application program needs to be updated.

In one embodiment of the present invention, if the host application program does not need to be updated, the host will display that the initialization is completed.

In one embodiment of the present invention, if the ID does not exist in the host temporary table of the host, and then the host checks whether a remote server exists, and data indicating that the ID is unsupported is transferred to the host and the host displays that the re-modularized sensing device is unsupported if the remote server does not exist.

In one embodiment of the present invention, if a remote server does exist, first, the ID is transferred to the remote server by the host, second, the ID is decoded by a decoder of the remote server, third, whether the ID is supported by a remote server database of the remote server is checked, fourth, the sensing device processing application program and the host application program corresponding to the ID are downloaded from the remote server database of the remote server to the host if the ID is supported by the remote server database. Finally, the sensing device processing application program of the re-modularized sensing device and the host application program of the host are updated.

In one embodiment of the present invention, if the remote server database of the remote server does not support the ID, data indicating that the ID is unsupported is transferred to the host, and the host displays that the re-modularized sensing device is unsupported, and the initialization is completed.

Compared to the prior art, the applicable situations of a single sensing device of the present invention are increased by applying a re-modularized sensing device, and the value of a single sensing device greatly increased.

### BRIEF DESCRIPTION OF THE DRAWINGS

FIG. 1 is a block diagram of a sensing system of the first preferred embodiment of the present invention.

FIG. 2 is an exploded diagram of the re-modularized sensing device of FIG. 1.

FIG. 3 is an assembled diagram of the re-modularized sensing device of FIG. 2.

FIG. 4 is a block diagram of the host of the sensing system of FIG. 1.

FIG. 5 is an exploded diagram of a re-modularized sensing device of the second preferred embodiment of the present invention.

FIG. 6 is a diagram of a sensing system of the third preferred embodiment of the present invention.

FIG. 7 is a diagram of the remote server of the sensing system of FIG. 6.

FIG. 8 is a flow chart of the initialization of the sensing system of FIG. 6.

### DETAILED DESCRIPTION OF THE PREFERRED EMBODIMENTS

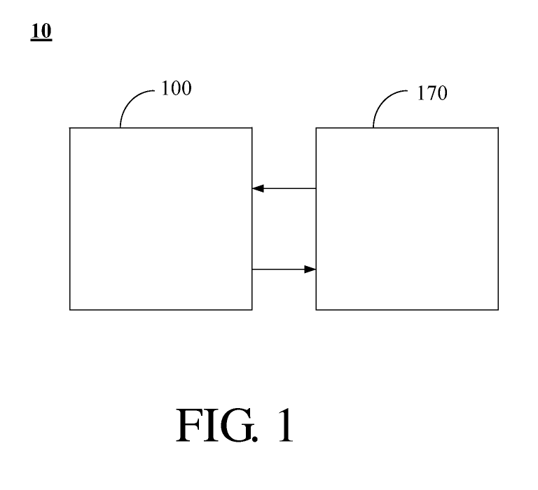

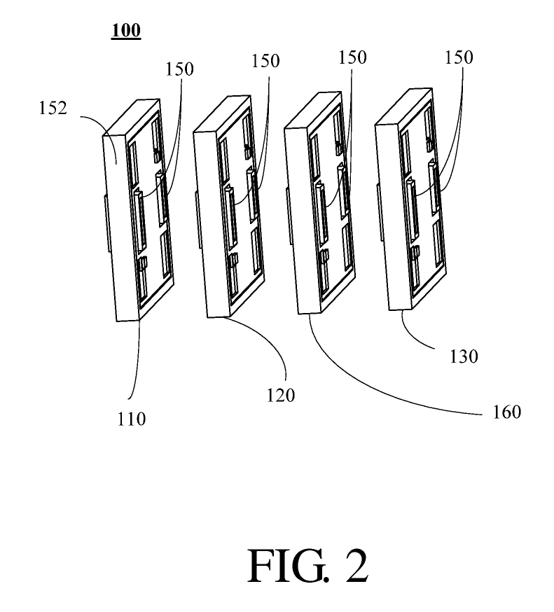

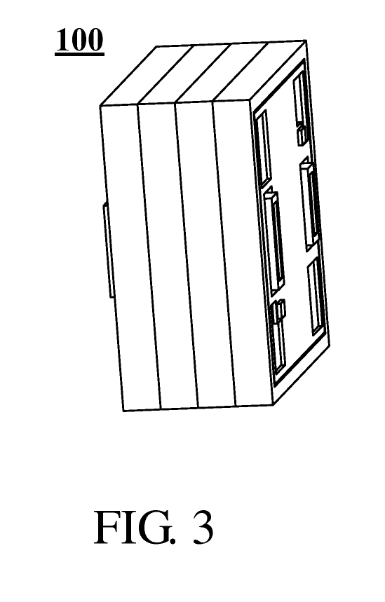

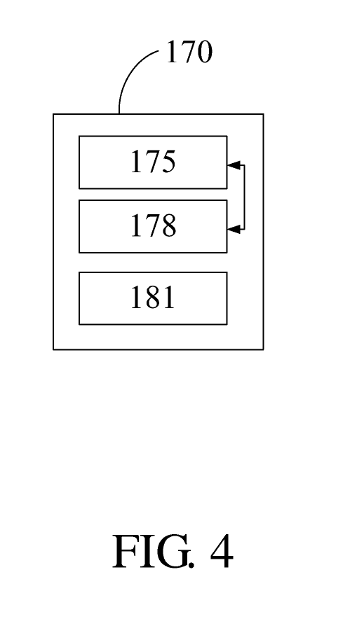

Refer to FIG. 1, FIG. 2, FIG. 3 and FIG. 4. FIG. 1 is a block diagram of a sensing system 10 of the first preferred embodiment of the present invention. FIG. 2 is an exploded diagram of the re-modularized sensing device 100 of FIG. 1. The re-modularized sensing device 100 can be used in different applicable situations, such as a concentration of alcohol, image, dB, etc. FIG. 3 is an assembled diagram of the re-modularized sensing device 100 of FIG. 2. FIG. 4 is a block diagram of the host 170 of the sensing system 10 of FIG. 1.

A sensing system 10 comprises a re-modularized sensing device 100 and a host 170.

The re-modularized sensing device 100 comprises a power unit 110, a sensing unit 120, a processing unit 130, and a transceiver unit 160. And each of the units comprises an ID.

The power unit 110 provides the electricity for the re-modularized sensing device. The sensing device 120 could have different functional sensing parts for sound, temperature, moisture, or pressure, for deriving environmental data. The sensing unit 120 derives at least one environmental data. The processing unit 130 has sensing device processing application program for calculating the environmental data and generating a first outcome. In particular, and the host 170 can identify the unit according to the ID. The re-modularized sensing device 100 transfers a first signal which comprises information of the IDs, and the first outcome is transferred to the host 170 by the transceiver unit 160.

The sensing unit 120, the processing unit 130, the transceiver unit 160, and the power unit 110 are assembled into one or more modules, and each module is individually removable and replaceable. Each unit could be a module. In other words, the power unit 110, the sensing unit 120, the processing unit 130, and the transceiver unit 160 could be four modules. Two or more than two units could be a module. For example, for different applicable situations, the sensing unit 120 and the processing unit 130 could be a module, and the transceiver unit 160 and the power unit 110 could be a module.

Each of the modules has at least one connector 150, and the connectors 150 of two modules are used to electrically and mechanically connect the two modules. Each module comprises at least one printed circuit board and a module cover 152, each module cover 152 has holes in specific positions to expose the connectors 150. The modules are connected by the connectors 150. In the preferred embodiment, each module has two connectors 150, but is not limit thereto, and the positions of the connectors 150 are not limited thereto. The connectors 150 could be anywhere on the module which would allow the modules be connected.

Refer to FIG. 3, the re-modularized sensing device 100 is combined into one piece by the connectors 150. In the first embodiment, each unit forms a module. So, there are four modules assembled by the connectors 150.

The host 170 comprises a host database 175, a host temporary table 178, and a display 181. Specifically, the host 170 could be a PC, mobile phone, or mobile devices.

The host uses information from the host temporary table 178 to verify the IDs of the first signal. The host temporary table 178 comprises at least one ID of the units and an address of each ID in the host database 175. The host database 175 stores at least one host application program and sensing device processing application program corresponding to the ID in the host temporary table 178. In addition, the host database 175 also stores used host application program and sensing device processing application program corresponding to the ID. Thus, the host 170 can get a specific location of the ID in the host database by the receiving ID, and read a desired application program from the host database 175. The host 170 generates a second outcome by calculation of the first outcome with the host application program.

In the preferred embodiment, when the re-modularized sensing device 100 doesn't have a suitable sensing device processing application program, the re-modularized sensing device 100 transfers the first signal including the ID to the host 170. After the host verifies the ID, the host 170 determines that the processing unit 130 of re-modularized sensing device 100 doesn't have a suitable sensing device processing application program to calculate the environmental data detected by the sensing unit 120, and an updated version for the sensing device processing application program is found in the host database 175, then the sensing device processing application program is seized and transferred to the re-modularized sensing device to calculate the first outcome if no suitable or updated sensing device processing application program is found. In addition, if the host 170 determines that the host application program is damaged or mistaken or an updated version is found in the host database 175, the updated version of the host application program is seized from the host database 175 and installed to the host 170, and then the second outcome is generated by calculation of the first outcome with the host application program accordingly.

After the sensing device processing application program and the host application program are both confirmed, and then the processing unit 130 uses the received sensing device processing application program to generate the first outcome by calculating the environmental data. Then, the re-modularized sensing device 100 transfers the first outcome to the host 170 by the transceiver unit 160, the host 170 calculates the first outcome and generates the second outcome by the host application program and displays the second outcome on the display 181. As mentioned above, due to the limitations of memory size, the re-modularized sensing device 100 can't equip large calculating application programs, so the first outcome is generated at a preliminary calculation by the sensing device processing application program, then the first outcome is transferred to the host 170, then the second outcome is generated at a further calculation by the updated host application program. Generally, the first outcome is merely a preliminary calculating result, the second outcome is a further calculating result, and a chart is included.

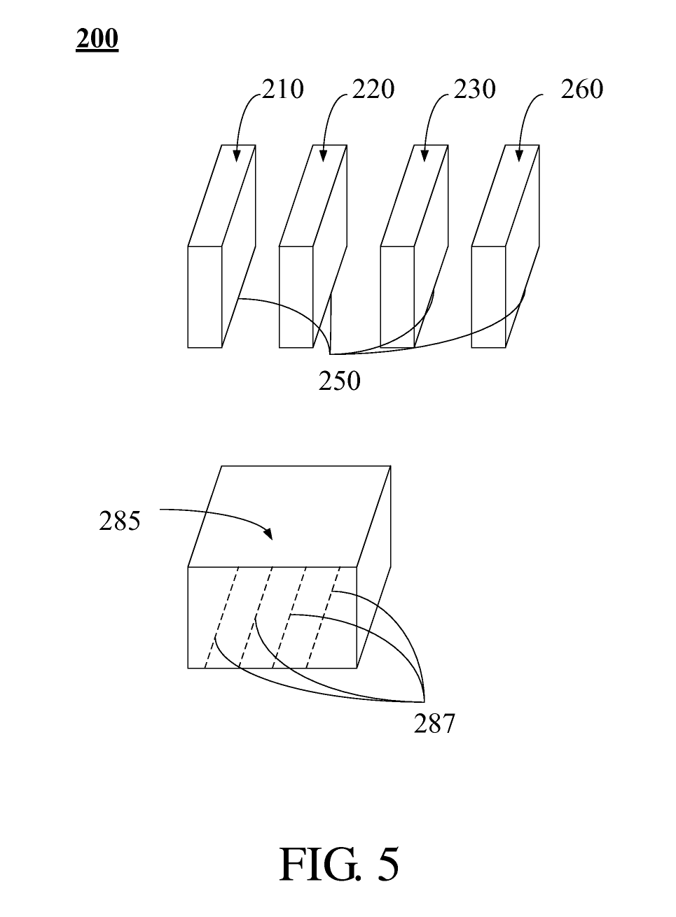

FIG. 5 is an exploded diagram of a re-modularized sensing device of the second preferred embodiment 200 of the present invention. The re-modularized sensing device 200 further comprises a device cover 285, and the device cover 285 further comprises at least one slot 287. The connectors 250 of each module are disposed on a bottom of the module. Modules are connected by the connectors 250 and the slots 287 with a sliding method. The difference between the second preferred embodiment and the first preferred embodiment is adding the device cover 285. In the second preferred embodiment of the present invention, each module connects with the device cover 285 by the connection of the connectors 285 of each module and the slots 287 of the device cover 285. But, in the first preferred embodiment of the present invention, each module directly connects with other modules by the connectors 285. And the slots 287 is based on a printed circuit board or other substrate, so with the connection of slots 287 of the device cover 285 and the connectors 250 of modules, the re-modularized sensing device 200 can work properly.

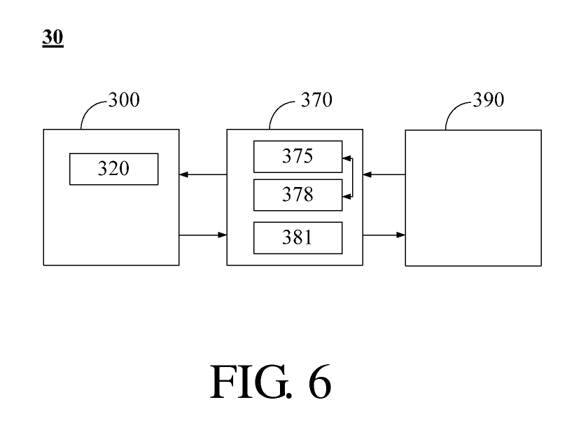

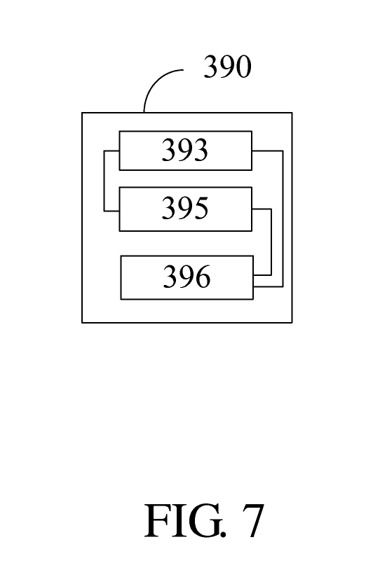

Refer to FIG. 6 and FIG. 7, FIG. 6 is a diagram of a sensing system 30 of the third preferred embodiment of the present invention, and FIG. 7 is a diagram of the remote server 390 of the sensing system 30 of FIG. 6. The difference between the third embodiment and the first embodiment is adding a remote server 390 to a system 30.

The remote server 390 further comprises an ID decoder 393, a remote server temporary table 395, and a remote server database 396. For the size of a program stored in the remote server 396 is too large to store in the host 370, in this manner, the calculation speed of the host 370 is also increased for the small size of a program at the same time.

In the preferred embodiment, when the re-modularized sensing device 300 doesn't have a suitable sensing device processing application program, the re-modularized sensing device 300 transfers the ID to the host 370. After the host 370 verifies the ID, if the host 370 can't find the ID in the host temporary table 378, in other words, the host database 375 doesn't have the sensing device processing application program and the host application program corresponding to the ID, and then the ID is encoded and transferred to the remote server 390. After the remote server 390 decodes the ID by the ID decoder 393, whether the remote server database 396 has the sensing device processing application program and the host application program corresponding to the ID is checked. Then, the sensing device processing application program and the host application program are seized and transferred to the re-modularized sensing device 300 and the host 370 for update if no suitable sensing device processing application program and the host application program corresponding to the ID is in the remote server database 396. The remote server 390 can also dispose a remote server temporary table 395 to shorten the time spent searching, and the method is not to search in the remote server database 396 directly, but to search in the remote server temporary table 395 for the address of the sensing device processing application program and the host application program corresponding to the ID in the remote server database 396. When data is large, the time spent will be shortened greatly accordingly. Then, the re-modularized sensing device 300 can calculate and generate the first outcome. Then, the host 370 can calculate and generate the second outcome by the first outcome. In other words, due to the limitations of a space of memory of the re-modularized sensing device 300, it is impossible to store too many or too large applications, so part of the applications is stored in the host 370. In this manner, the sensing device processing application program is used for the preliminary calculation of the environmental data, and then the first outcome is further calculated by the host application program, with the division of work, the efficiency will be raised.

In addition, after the ID decoder 393 decodes the ID transferred by the host 370, the remote server 390 can further verify whether the unit corresponding to the ID is the duly authorized version, and when an unduly authorized version of unit is found, the update is terminated. This could discourage a general user from using an unduly authorized unit. Then, the host application program and the sensing device processing application program corresponding to the ID are found directly in the remote server database 396, or indirectly by using the remote server temporary table 395 which is used to shorten the time spent on searching the sensing device processing application program.

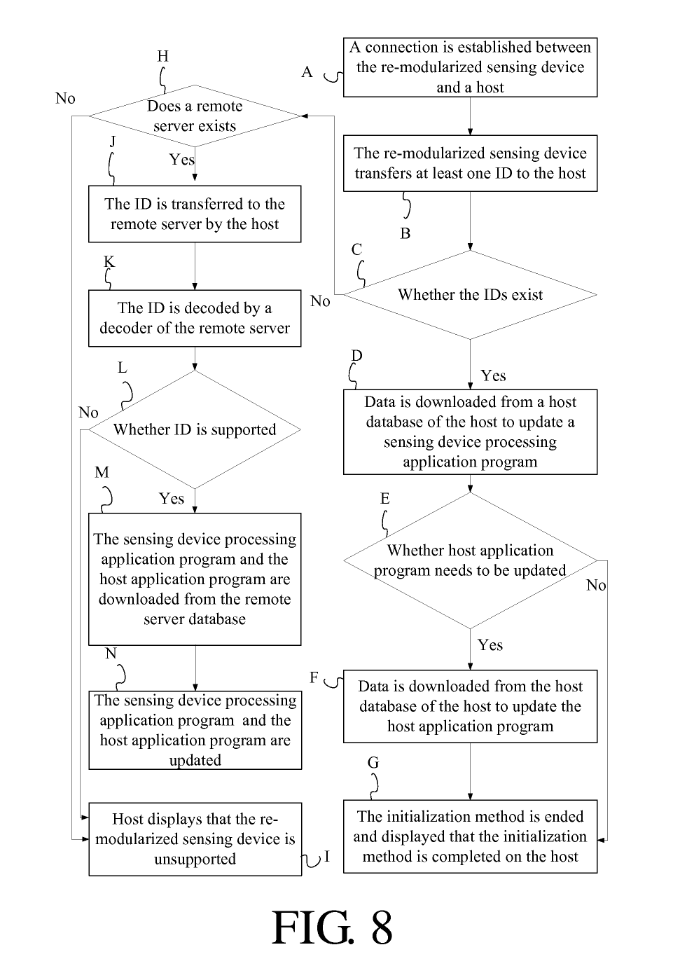

FIG. 8 is a flow chart of the initialization 30 of the sensing system of FIG. 6. In one embodiment, in process A, a connection is established between the re-modularized sensing device 300 and a host 370. In process B, the re-modularized sensing device 300 transfers at least one ID to the host 370. In process C, the host 370 checks whether the IDs exist in a host temporary table 378 of the host 370.

If the ID exists in the host temporary table 378 of the host 370, then in process D, data is downloaded from a host database 370 of the host 370 to update a sensing device processing application program. Then in process E, whether a host application program of the host 370 needs to be updated is checked.

If the host application program of the host 370 needs to be updated. Then in process F, data is downloaded from the host database 375 of the host 370 to update the host application program. In process the initialization method is ended and displayed that the initialization method is completed on the host 370.

If the host application program of the host 370 does not need to be updated, then in process G, the initialization method is ended and displayed that the initialization method is completed on the host 370.

In process C, if the ID does not exist in the host temporary table 378 of the host 370, then proceeding to process H, the host 370 checks whether a remote server 390 exists. If the remote server 390 does not exist, then proceeding to process I, data indicating that the ID is unsupported is transferred to the host 370, and the host 370 will display that the re-modularized sensing device 300 is unsupported.

In process H, if the remote server 390 exists, then proceeding to process J, the ID is transferred to the remote server 390 after the ID is encoded by the host 370. In process K, the ID is decoded by a decoder 393 of the remote server 390. In process L, whether the ID is supported by a remote server database 396 of the remote server is checked. If the remote server 396 supports the ID, then proceeding to process M, the sensing device processing application program and the host application program corresponding to the ID are downloaded from the remote server database 396 of the remote server 390 to the re-modularized sensing device 300 and the host 370. In process N, the sensing device processing application program of the re-modularized sensing device 300 and the host application program of the host 370 are updated.

In process L, if the remote database 396 of the remote server 390 does not support the ID, then proceeding to process I, data indicating that the ID is unsupported is transferred to the host 370, the host 370 displays that the re-modularized sensing device 300 is unsupported, and the initialization method is completed.

Although the present invention has been disclosed as preferred embodiments, the foregoing preferred embodiments are not intended to limit the present invention. Those of ordinary skill in the art, without departing from the spirit and scope of the present invention, can make various modifications and variations to the present invention. Therefore, the scope of the claims of the present invention must be defined.

What is claimed is:

1. A sensing system having a re-modularized sensing device, comprising.
a host;
a re-modularized sensing device comprising:
a power unit providing electricity for the modularized sensing device;
a sensing unit deriving at least one environmental data;
a processing unit having a sensing device processing application program for calculating the environmental data and generating a first outcome; and
a transceiver unit transferring the first outcome and a first signal to the host,
wherein each sensing unit, processing unit, transceiver unit, and power unit has an ID, the sensing unit, processing unit, transceiver unit, and power unit are assembled into one or more modules, and each module is individually removable and replaceable.

2. The sensing system according to claim 1, wherein each of the modules has at least one connector, and the connectors of two modules form electrical and mechanical connections therebetween when the two modules are assembled.

3. The sensing system according to claim 1, wherein the first signal comprises information of the ID of the sensing unit.

4. The sensing system according to claim 1, wherein the host further comprises:
a host database storing at least one host application program and sensing device processing application program corresponding to the ID; and
a host temporary table storing an address of each ID in the host data base.

5. The sensing system according to claim 4, wherein the re-modularized sensing device preliminarily calculates the environmental data by using the sensing device processing application program, and the host calculates the first outcome by using the host application program.

6. The sensing system according to claim 1, wherein each module has at least one connector, the re-modularized sensing device further comprises a device cover, the device cover comprises a plurality of slots, and each module is installed into the device cover by connecting the connectors with the slots.

7. A sensing system using a re-modularized sensing device, comprising:
a remote server;
a host communicating with the remote server;
a re-modularized sensing device comprising:
a power unit providing electricity for the modularized sensing device;
a sensing unit deriving at least one environmental data;
a processing unit having a sensing device processing application program for calculating the environmental data and generating a first outcome; and
a transceiver unit transferring the first outcome and a first signal to the host,
wherein each sensing unit, processing unit, transceiver unit, and power unit has and ID, the sensing unit, processing unit, transceiver unit, and power unit are assembled into one or more modules, and each module is individually removable and replaceable.

8. The sensing system according to claim 7, wherein each of the modules has at least one connector, and the connectors of two modules form electrical and mechanical connections therebetween when the two modules are assembled.

9. The sensing system according to claim 7, wherein the first signal comprises information of the ID of the sensing unit.

10. The sensing system according to claim 7, wherein the host further comprises:
a host database storing at least one host application program and sensing device processing application program corresponding to the ID; and
a host temporary table storing an address of each ID in the host database.

11. The sensing system according to claim 10, wherein the re-modularized sensing device preliminarily calculates the environmental data by using the sensing device processing application program, and the host calculates the first outcome by the host application program.

12. The sensing system according to claim 7, wherein the remote server further comprises:
an ID decoder decoding the ID transferred from the host; and
a remote server database storing at least one host application program and sensing device processing application program corresponding to the ID.

13. The sensing system according to claim 12, wherein the remote server further comprises a remote server temporary table storing an address of each ID in the remote server database.

14. The sensing system according to claim 7, wherein each module has at least one connector, the re-modularized sensing device further comprises a device cover, the device cover comprises a plurality of slots, and each module is installed into the device cover by connecting the connectors with the slots.

15. An initialization method of a sensing system using a re-modularized sensing device, comprising:
checking whether a sensing unit is supported by the re-modularized sensing device;
establishing a connection between the re-modularized sensing device and a host when the sensing unit is not supported by the re-modularized sensing device;
transferring an ID of the sensing unit to the host from the re-modularized sensing device;
checking whether the ID exists in a host temporary table of the host;
downloading data from a host database of the host to update a sensing device processing application program if the ID exists in the host temporary table;
checking whether a host application program of the host needs to be updated;
downloading data from the host database of the host to update the host application program if the host application program needs to be updated.

16. The initialization method according to claim 15, wherein if the host application program of the host does not need to be updated, the host will display that the initialization is completed.

17. The initialization method according to claim 15, further comprising:
checking whether a remote server exists; and
transferring data indicating that the ID is unsupported to the host and displaying by the host that the re-modularized sensing device is unsupported if the remote server does not exist.

18. The initialization method according to claim 17, if the remote server exists, the method further comprises:
transferring the ID to the remote server by the host;
decoding the ID by a decoder of the remote server;
checking whether the ID is supported by a remote server database of the remote server;
downloading the sensing device processing application program and the host application program corresponding to the ID from the remote server database of the remote server to the host if the ID is supported by the remote server database; and
updating the sensing device processing application program of the re-modularized sensing device and the host application program of the host.

19. The initialization method according to claim 18, if the remote server database of the remote server does not support the ID, transferring data to the host, and displaying by the host that the re-modularized sensing device is unsupported, and completing the initialization.
